(19) United States
(12) Patent Application Publication
(10) Pub. No.: US 2014/0015245 A1
(43) Pub. Date: Jan. 16, 2014

(54) MULTI-DIRECTION FASTENING DEVICE FOR FASTENING A PLURALITY OF WIRING ELEMENTS

(71) Applicant: Teh-Tsung CHIU, New Taipei City (TW)

(72) Inventor: Teh-Tsung CHIU, New Taipei City (TW)

(73) Assignee: AVC INDUSTRIAL CORP.

(21) Appl. No.: 13/548,037

(22) Filed: Jul. 12, 2012

(51) Int. Cl. F16L 41/00

(52) U.S. Cl. 285/133.11

(57) ABSTRACT

A multi-direction fastening device for fastening a plurality of wiring elements is provided. The fastening device includes a casing having a front thread defining a front hole, a first rear thread defining a first read hole, a second rear thread defining a second rear hole, and a third rear thread defining a third rear hole. A first fastening component is fastened to the first rear thread. A second fastening component is fastened to the second rear thread. A third fastening component is fastened to the third rear thread. A first wiring element can pass the front hole and the first rear hole. A second wiring element can pass the front hole and the second rear hole. A third wiring element can pass the front hole and the third rear hole. The front hole can be engaged with a hole of an electric box, a board or a wall.

### BACKGROUND OF THE INVENTION

1. Field of the Invention

This invention relates to fastening devices, and, more particularly, to a multi-direction fastening device for fastening a plurality of wiring elements.

2. Description of Related Art

In modern society, wiring elements (e.g., optical fibers, cables, telephone lines and wires) are widely applied to transmitting a variety of signals, such as TV signals and network signals. Before entering a building or a machine, wiring elements have to be fastened by a fastening device to a board (e.g., a machine board, a wall or an electric box) of the building or machine first, and then branched to various units.

Please refer to FIG. 1, which is an exploded view of a fastening device disclosed in U.S. Pat. No. 5,927,892, for fastening a wiring element to a machine board. The fastening device comprises a lock nut 10, a washer 20, a casing 30, a collar 40, a clamp 50 and a chuck 60, for the wiring element to pass therethrough sequentially. The casing 30 has a front hole 33, a rear hole 34 in communication with the front hole 33, a front outer thread 31 surrounding the front hole 33, and a rear outer thread 32 surrounding the rear hole 34. The front outer thread 31 can pass a hole of the machine board. The lock nut 10 and the washer 20 can be mounted onto a portion of the front outer thread 31 that passes the hole of the machine board (or an electric box), to fasten the casing 30 to the machine board. The collar 40 can be embedded in the front hole 33 and the rear hole 34 of the casing 30, and spaced at a gap from inner walls of the front hole 33 and the rear hole 34. The clamp 50 has a hole 51, pawls 52, and engagement portions 53 installed on inner sides of the pawls 52. When the clamp 50 is mounted onto the collar 40, the engagement portions 53 prop against a reduced tail section 42 of the collar 40. Then, the chuck 60 can be mounted onto the clamp 50, and an inner thread 62 of the chuck 60 can be screwed with the rear outer thread 32 of the casing 30. As a result, the tapered inner wall portion 61 of the chuck 60 compels the engagement portions 53 to the reduced tail section 42, such that the wiring element can be fastened securely by the fastening device to the machine board.

Since the casing 30 of the fastening device has only one rear hole (i.e., the rear hole 34), besides the front hole 33, only one wiring element is allowed to pass the fastening device and be fastened to the machine board. However, along with the rapid development of network applications and cloud technology, the fastening device has to fasten a plurality of wiring elements over which a variety of signals are transmitted to the hole of the machine board. Accordingly, the hole of the machine board and the front hole 33 and the rear hole 34 of the casing 30 may have their radiuses be increased, in order to allow a plurality of wiring elements to pass the fastening device and be fastened to the machine board (or the electric box).

However, the wiring elements are close to one another since passing from the collar 40, through the rear hole 34 and to the front hole 33. As a result, a variety of signals transmitted over the wiring elements are interfered. Besides, the wiring elements, since coming from different directions, have to be bent in a bending region outside the fastening device before entering the fastening device. A portion of the wiring elements in the bending region is at the risk of damages. Since the bending region is outside the fastening device, as the wiring elements in the bending region are damaged, transmission lines in the wiring elements are exposed and the transmission quality of the signals are affected significantly.

Therefore, a long-felt need to providing a fastening device to solve the above-mentioned problems is not yet met.

### SUMMARY OF THE INVENTION

In view of the above-mentioned problems of the prior art, the present invention provides a multi-direction fastening device for fastening a plurality of wiring elements. The fastening device includes a casing, a first fastening component, a second fastening component, and a third fastening component.

The casing has a front thread defining a front hole, a first rear thread defining a first rear hole in communication with the front hole, a second rear thread defining a second rear hole in communication with the front hole, and a third rear thread defining a third rear hole in communication with the front hole.

The first fastening component is fastened to the first rear thread.

The second fastening component is fastened to the second rear thread.

The third fastening component is fastened to the third rear thread.

In an embodiment of the present invention, the first fastening component is further engaged with a first wiring element, the second fastening component is further engaged with a second wiring element, and the third fastening component is further engaged with a third wiring element.

In an embodiment of the present invention, the first wiring element, the second wiring element and the third wiring element are cable adaptors.

In an embodiment of the present invention, the first wiring element, the second wiring element and the third wiring element are conduit adaptors.

In an embodiment of the present invention, a first connection line between the front hole and the second rear hole is perpendicular to a second connection line between the first rear hole and the third rear hole.

In an embodiment of the present invention, the casing is in the shape of a box.

In an embodiment of the present invention, the front hole is in communication with and engaged with a hole of a board.

In an embodiment of the present invention, the front thread is further engaged with a front fastening component.

In an embodiment of the present invention, the front hole is further engaged with a piping element.

In an embodiment of the present invention, the front hole is further engaged with a washer and a screw-in plug.

In an embodiment of the present invention, the second rear hole corresponds in position to the front hole, the first rear hole corresponds in position to the third rear hole, and a first connection line between the front hole and the second rear hole is perpendicular to a second connection line between the first rear hole and the third rear hole, to form a T-shaped three-direction fastening device. With the use of a variety of cable adaptors, cables can be fastened by the fastening device and prevent from water and being pulled by external forces.

In an embodiment of the present invention, the first fastening component is an adaptor that allows the first wiring element to be engaged therein. The adaptor has a thread installed on one end thereof for being screwed with the first rear thread. The second fastening component is an adaptor that allows the second wiring element to be engaged therein. The adaptor has a thread installed on one end thereof for being screwed with the second rear thread. The third fastening component is an adaptor that allows the third wiring element to be engaged therein. The adaptor has a thread installed on one end thereof for being screwed with the third rear thread. In an embodiment of the present invention, the adaptor is a cable adaptor, a conduit adaptor, or a telephone line adaptor, which are all water-proof and compel wiring elements.

In an embodiment of the present invention, the front hole comprises a washer and a screw-in plug, or the front hole comprises a piping element engaged therein.

Since the casing of the fastening device has a plurality of rear holes, a plurality of wiring elements (e.g., cables, optical fibers, telephone lines, or conduit inside which cables, optical fibers or telephone lines are installed) coming from different directions can enter the rear holes, then bend in a bending region inside the casing, and finally pass the front hole. Therefore, the wiring elements are not close to one another before entering the front hole. As a result, a variety of signals transmitted over the wiring elements are not likely to be interfered. Since the wiring elements are not bent until they enter the casing, and the bending region is inside the casing, the wiring elements are not likely to be cracked due to the sunshine. Even if the wiring elements in the bending region are damaged, the transmission lines will not be eroded by rain or dust, and signals transmitted over the wiring elements are not affected.

### BRIEF DESCRIPTION OF DRAWINGS

The invention can be more fully understood by reading the following detailed description of the preferred embodiments, with reference made to the accompanying drawings, wherein:

FIG. 1 is an exploded view of a fastening device for fastening a wiring element to a board according to the prior art;

FIGS. 2A-2D are a front view, a left view, a right view and a top view of a casing of a fastening device of an embodiment according to the present invention, respectively;

FIG. 3 is a front view of a fastening device of an embodiment according to the present invention;

FIGS. 4A and 4B are a front view of a fastening device and a structural view of a conduit fastening component of another embodiment according to the present invention, respectively;

FIG. 5 shows exploded and assembled views of a rear fastening component of a fastening device of an embodiment according to the present invention, respectively;

FIG. 6 is a schematic diagram of a screw-in plug and a washer of an embodiment according to the present invention; and

FIG. 7 is a diagram illustrating that the screw-in plug and the washer are engaged with the fastening device according to the present invention.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

In addition to a front hole, a fastening device according to the present invention further comprises a plurality of (e.g., three) rear holes, allowing a plurality of (e.g., three) wiring elements to pass therein.

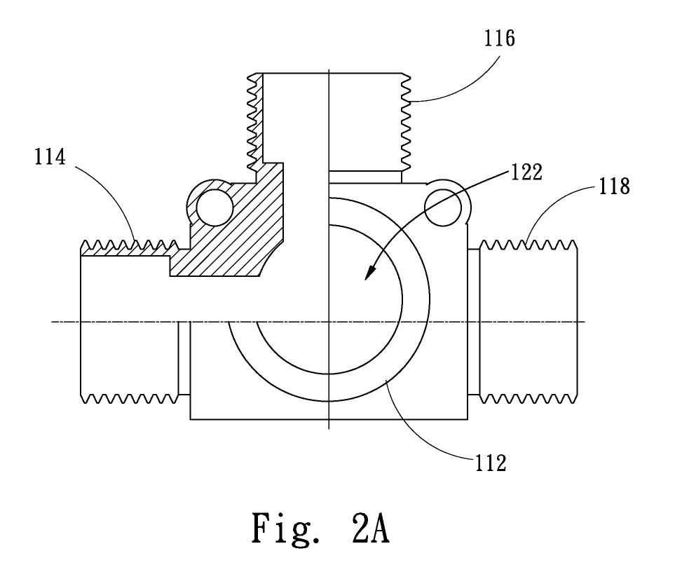

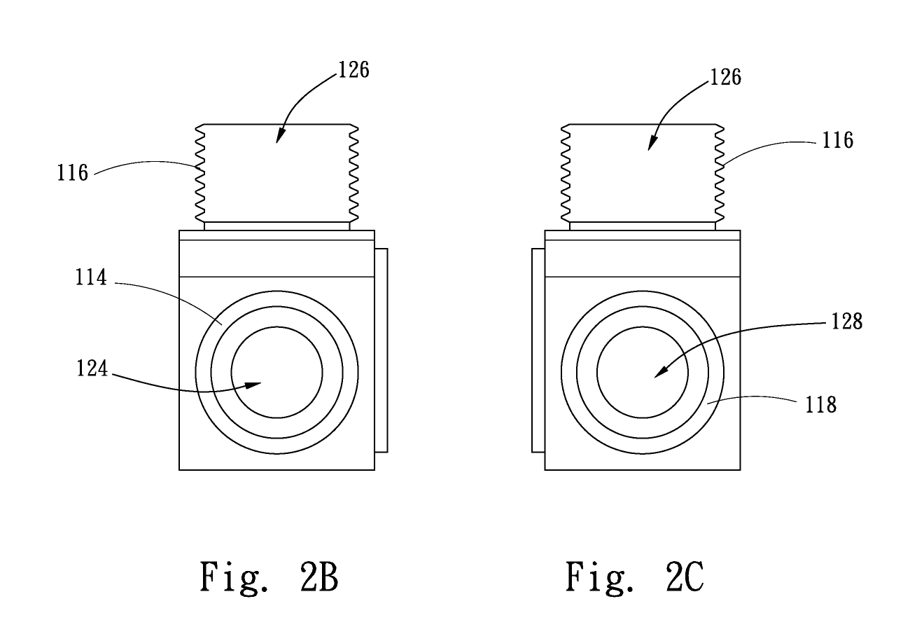

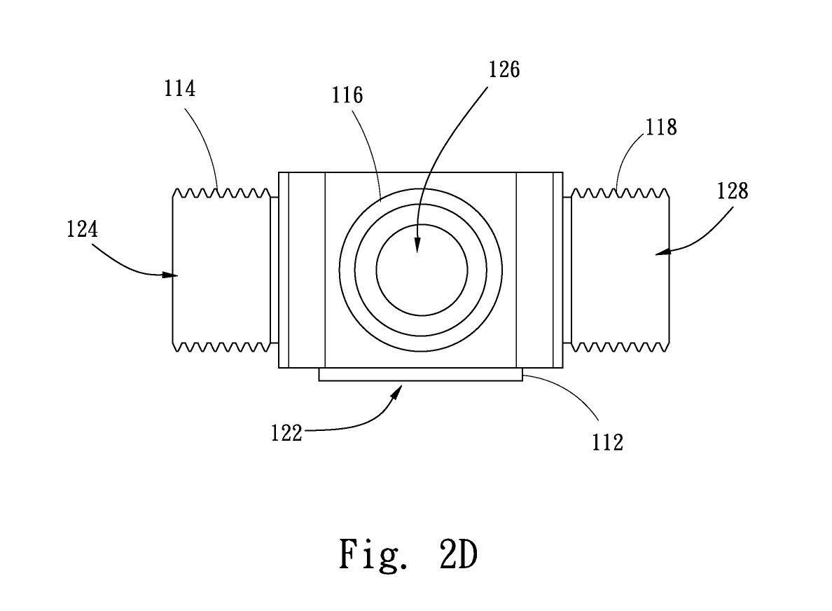

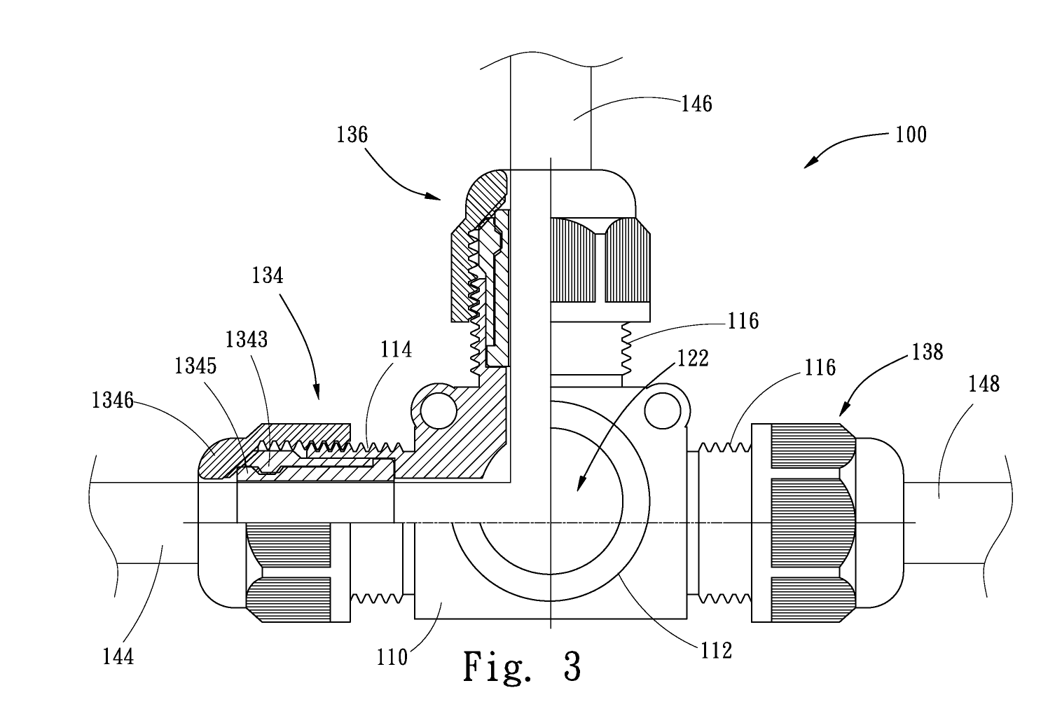

Please refer to FIGS. 2A-2D, which are a front view, a left view, a right view and a top view of a casing 110 of a fastening device 100 according to the present invention. The casing 110 comprises a front thread 112, a first rear thread 114, a second rear thread 116, and a third rear thread 118. In an embodiment, the front thread 112 is an inner thread defining a front hole 122. The first rear thread 114 defines a first rear hole 124 in communication with the front hole 122, allowing a first wiring element 144 (see FIG. 3) to be engaged with the first rear hole 124 and the front hole 122. The second rear thread 116 defines a second rear hole 126 in communication with the front hole 122, allowing a second wiring element 146 (see FIG. 3) to be engaged with the second rear hole 126 and the front hole 122. The third rear thread 118 defines a third rear hole 128 in communication with the front hole 122, allowing a third wiring element 148 (see FIG. 3) to be engaged with the third rear hole 128 and the front hole 122.

In an embodiment, the second rear hole 126 corresponds in position to the front hole 122, the first rear hole 124 corresponds in position to the third rear hole 128, and a first connection line between the front hole 122 and the second rear hole 126 is perpendicular to a second connection line between the first rear hole 124 and the third rear hole 128. In other words, the first rear hole 124, the second rear hole 126, and the third rear hole 128 of the casing 110 form a T-shaped three-direction fastening device. Three wiring elements (e.g., three cables) can be fastened by the fastening device 100. With the use of a variety of cable adaptors, cables can be fastened by the fastening device 100 and prevent from water and being pulled by external forces. In another embodiment of the present invention, the board is a machine board, a wall or an electric box. Accordingly, the casing 110 is in the shape of a box such that the box-shaped casing 110 can be fastened securely to the wall or to the machine board. Screw holes can be further installed on the casing 100, for a user to fasten the casing 110 to, for example, the machine board with screws.

Please refer to FIG. 3, which is a front view of the fastening device 100 of an embodiment according to the present invention. The fastening device 100 further comprises a first fastening component 134 fastened to the first rear thread 114, a second fastening component 136 fastened to the second rear thread 116, and a third fastening component 138 fastened to the third rear thread 118. In the fastening device 100 shown in FIG. 3, the first fastening component 134, the second fastening component 136, and the third fastening component 138 are all cable adaptors, each of which comprises a lock nut 1341, a clamp 1343, and a collar 1345. The collar 1345 is engaged with an inner side of the clamp 1343, and the clamp 1343 is installed in the lock nut 1341. Accordingly, the first wiring element 144, the second wiring element 146 and the third wiring element 148 are all cables, telephone lines or optical fibers. With the use of a plurality of cable adaptors, the cables, the telephone lines and the optical fibers can pass the collar 1345, and the clamp 1343 clamps a neck portion 1346 of the collar 1345. The lock nut 1341 is engaged with the first fastening component 134, the second fastening component 136 or the third fastening component 138, allowing the first wiring element 144 to be engaged with the first fastening component 134, the second wiring element 146 to be engaged with the second fastening component 136, or the third wiring element 148 to be engaged with the third fastening component 138. The engaged cables, telephone lines and optical fibers converge in the casing 110 and pass through the front hole 122 into the hole of the board (not shown) engaged.

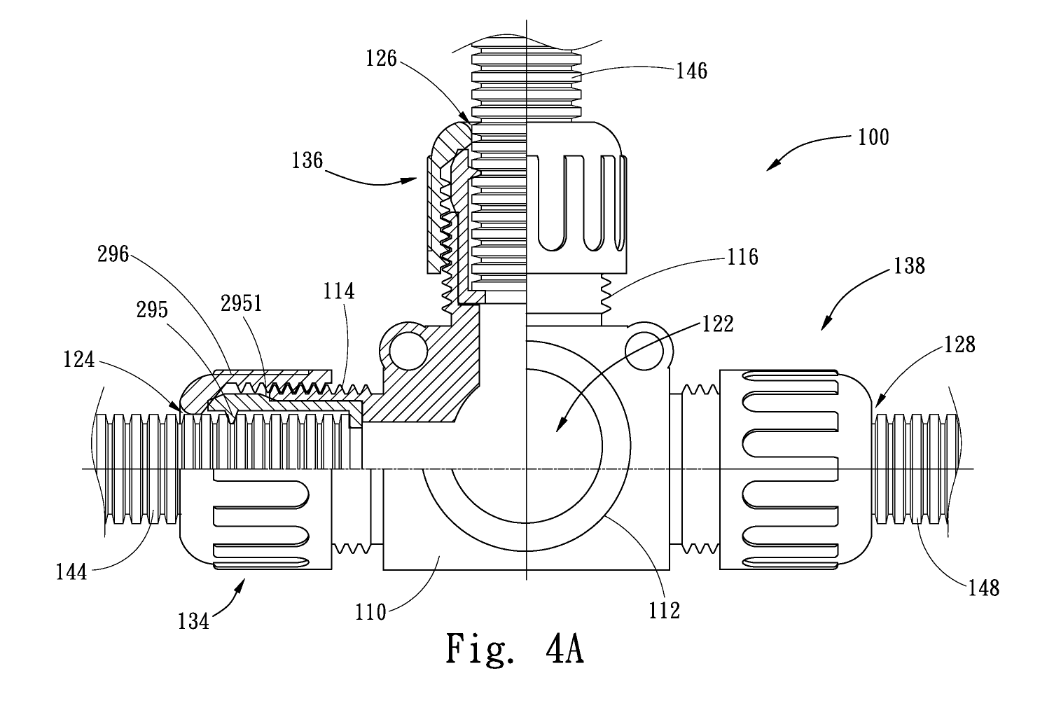

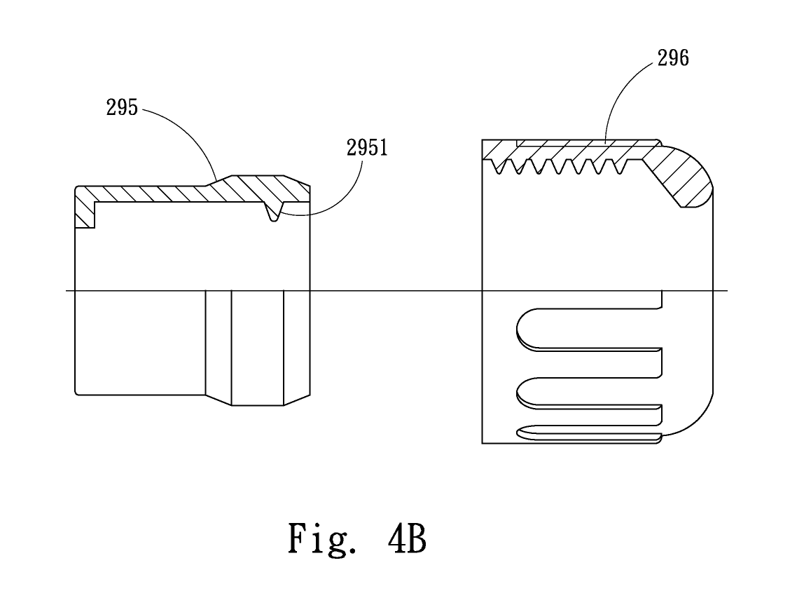

Please refer to FIGS. 4A and 4B, which are a front view of the fastening device 100 and a structural view of a conduit fastening component of another embodiment according to the present invention, respectively. In the fastening device 100 shown in FIG. 4A, the first fastening component 134, the second fastening component 136, and the third fastening component 138 are all conduit fastening components. Accordingly, the first wiring element 144, the second wiring element 146 and the third wiring element 148 are all conduits. Therefore, the first wiring element 144 can be engaged with the first fastening component 134, the second wiring element 146 can be engaged with the second fastening component 136, or the third wiring element 148 can be engaged with the third fastening component 138. The conduit fastening components (referring to FIG. 4B) comprise compelling lock nuts 296 engaged with the first rear thread 114, the second rear thread 116 and the third rear thread 118, respectively. A clamp 295 is engaged with an inner side of the compelling lock nut 296. The clamp 295 comprises a hook 2951. The hook 2951 is hooked to a concave portion of the conduit after the compelling lock nut 296 is compelled. Therefore, cables, telephone lines and optical fibers can be installed in the conduit and bent in the bending region inside the casing, and enter the front hole 122 and a hole of a board (not shown).

In an embodiment shown in FIGS. 3 and 4A, the first fastening component 134, the second fastening component 136 and the third fastening component 138 of the fastening device 100 are of the same type. However, in another embodiment of the present invention, the first fastening component 134, the second fastening component 136 and the third fastening component 138 are different from one another, in order to fasten wiring elements of different types.

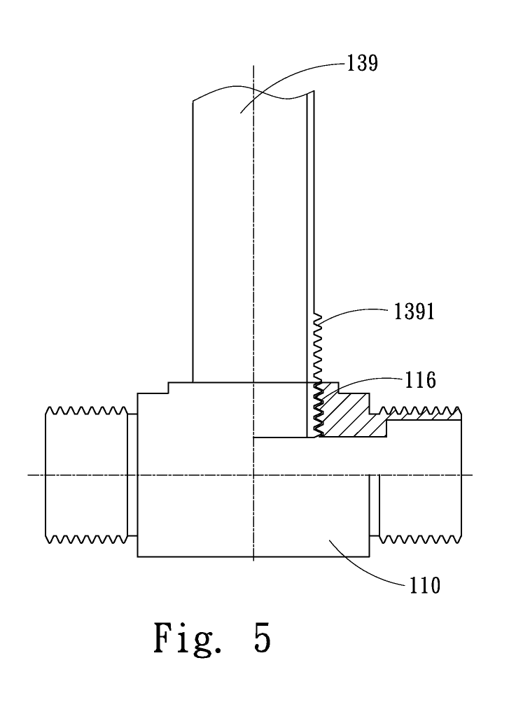

Please refer to FIG. 5. In an embodiment of the present invention, the front hole 122 is further engaged with a piping element 139, cables or optical fibers can be mounted in and protected by the piping element, and piping element 139 is further engaged with a board.

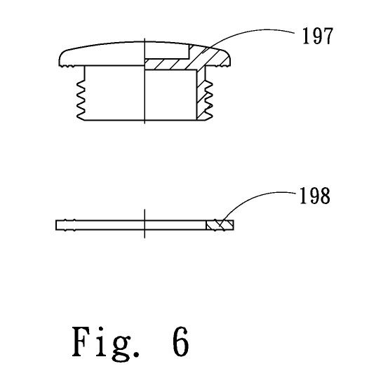

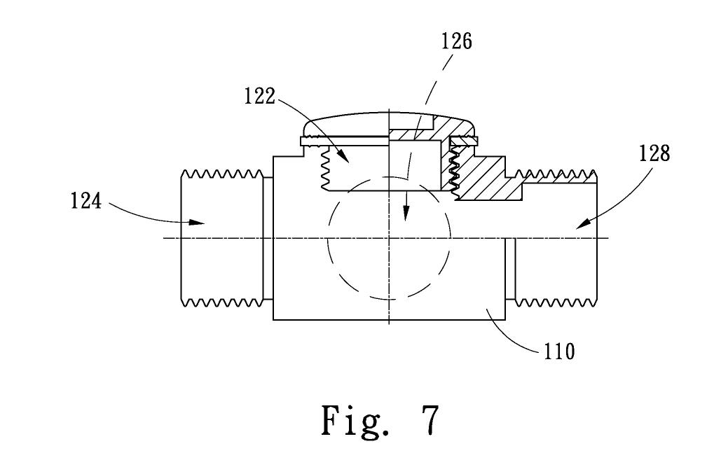

Please refer to FIGS. 6 and 7. In an embodiment of the present invention, the wiring elements of the first rear hole 124, the second rear hole 126 and the third rear hole 128 do not pass the front hole 122. In order to prevent moisture or dust from entering the casing 11, the front hole 122 has a screw-in plug 197 and a washer 198.

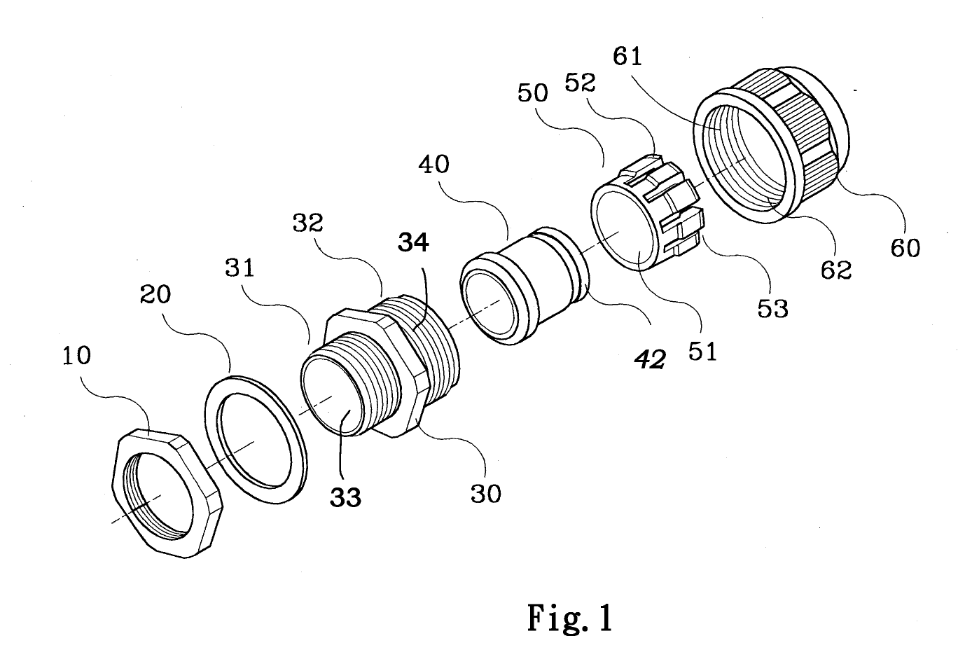

In an embodiment of the present invention, the first rear hole 124 of the fastening device 100 is further engaged with a front fastening component. For instance, the casing 30 shown in FIG. 1 can be screwed with the front thread 112, to fasten the casing 110 to a hole or screw hole of a board (not shown).

Since the casing 110 of the fastening device 100 has three rear holes (i.e., the first rear hole 124, the second rear hole 126 and the third rear hole 128) , three wiring elements (e.g., cables, optical fibers, telephone lines or conduits in which cables, optical fibers and telephone lines are installed) coming from different directions pass the rear holes, then bend in a bending region inside the casing 100, and finally pass the front hole 122. As a result, the three wiring elements are not close to one another before entering the casing 110, and a variety of signals transmitted over the wiring elements are not likely to be interfered. Since the wiring elements are bent in the casing 110, and the bending region is inside the casing 110, even if the wiring elements in the bending region are damaged and the transmission lines inside the wiring elements are exposed, the exposed transmission lines will not be eroded by rain or dust and signals transmitted over the transmission lines are not interfered. The provision of the fastening device according to the present invention meets the long-felt but unmet need.

The fastening device according to the present invention has a special three-direction design, can cooperate with a locking compelling mechanism, can be applied to a variety of fields (e.g., vehicles, machines, communication, wireless network room, and plant engineering) and can be installed on any apparatus (e.g., solar panel, communication wiring, LED lighting, digital displaying, traffic light, and detecting and monitoring device).

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A multi-direction fastening device for fastening a plurality of wiring element, the multi-direction fastening device comprising: a casing, a first fastening component, a second fastening component and a third fastening component;
the casing comprising: a front thread defining a front hole; a first rear thread defining a first rear hole in communication with the front hole; a second rear thread defining a second rear hole in communication with the front hole; and a third rear thread defining a third rear hole in communication with the front hole;
the first fastening component being fastened to the first rear thread;
the second fastening component fastened to the second rear thread;
the third fastening component fastened to the third rear thread.

2. The multi-direction fastening device of claim 1, wherein the first fastening component is further engaged with a first wiring element, the second fastening component is further engaged with a second wiring element, and the third fastening component is further engaged with a third wiring element.

3. The multi-direction fastening device of claim 2, wherein the first wiring element, the second wiring element and the third wiring element are cable adaptors.

4. The multi-direction fastening device of claim 3, wherein a first connection line between the front hole and the second rear hole is perpendicular to a second connection line between the first rear hole and the third rear hole.

5. The multi-direction fastening device of claim 2, wherein the first wiring element, the second wiring element and the third wiring element are conduit adaptors.

6. The multi-direction fastening device of claim 1, wherein the casing is in the shape of a box.

7. The multi-direction fastening device of claim 1, wherein the front hole is engaged with a hole of a board.

8. The multi-direction fastening device of claim 1, wherein the front thread is further engaged with a front fastening component.

9. The multi-direction fastening device of claim 1, wherein the front hole is further engaged with a piping element.

10. The multi-direction fastening device of claim 1, wherein the front hole is further engaged with a washer and a screw-in plug.
